(19) United States
(12) Patent Application Publication
(10) Pub. No.: US 2026/0004978 A1
(43) Pub. Date: Jan. 1, 2026

(54) REMOTE SWITCH ACTUATOR WITH CONTINUOUS FEEDBACK

(71) Applicant: CBS ArcSafe, Inc., Denton, TX (US)

(72) Inventors: Finley Ledbetter, Argyle, TX (US); Ashley Ledbetter, Argyle, TX (US); Benjamin R. Walterscheid, Argyle, TX (US); Kyle Fincher, Decatur, TX (US); Michael Fierro, Krum, TX (US); Lucas Carfagna, Charleston, WV (US)

(73) Assignee: CBS ArcSafe, Inc., Denton, TX (US)

(21) Appl. No.: 19/247,958

(22) Filed: Jun. 24, 2025

Related U.S. Application Data
(60) Provisional application No. 63/665,299, filed on Jun. 28, 2024.

(51) Int. Cl. H01H 3/50; H01H 3/46; H01H 71/00; H01H 71/02; H01H 71/04

(52) U.S. Cl. CPC H01H 3/50; H01H 3/46; H01H 71/04; H01H 2071/006; H01H 2071/0292; H01H 2071/048; H01H 2239/048; H01H 2300/052

(57) ABSTRACT

A remote switch actuator includes an actuator housing having a push plate coupled to a pair of actuator pins, the push plate having a first state where the push plate is disposed about an end of an actuation path and a second state where the push plate is disposed about an opposed end of the actuation path. The remote switch actuator may further include at least one sensor positioned within the actuator housing and configured to continuously detect the position of the push plate along the actuation path. The remote switch actuator may further include a switch controller communicatively coupled to the actuator housing and the at least one sensor and having a user interface configured to display the position of the push plate sensed by the at least one sensor.

### CROSS-REFERENCE TO RELATED PATENT APPLICATIONS

This application claims priority to and the benefit of U.S. Provisional Application Ser. No. 63/665,299, filed on Jun. 28, 2024, the entirety of which is incorporated herein by reference for all purposes.

### BACKGROUND

Molded case circuit breaker (“MCCB”) is a type of circuit breaker that is commonly used in electrical distribution systems to protect circuits from overloads and short circuits. MCCBs are designed to handle higher current ratings than miniature circuit breakers (“MCB”s) and are often used in industrial and commercial applications where higher power levels are involved. They typically consist of a molded case housing the internal components, such as the contacts, trip mechanism, and arc extinguishers. MCCBs must be properly maintained to provide reliable protection against various electrical faults. Certain hazards arise with the required maintenance of MCCBs as the MCCB must be manually tripped or closed.

One such hazard is as an arc flash hazard, which is a sudden release of electrical energy through the air, resulting in an explosion-like burst of heat and light. Arc flashes can generate intense heat, reaching temperatures of thousands of degrees Celsius, leading to severe burns and ignition of nearby flammable materials. During an arc flash event, molten metal and debris can be ejected at high velocities, posing a risk of injury to personnel in the area. This debris can cause lacerations, puncture wounds, and eye injuries. Arc flashes can also generate a rapid expansion of air which can generate a pressure wave or blast, similar to an explosion. This blast can cause physical trauma, including concussions and internal injuries, to individuals nearby. Arc flashes can also cause extensive damage to electrical equipment and infrastructure, leading to costly downtime, repairs, and replacement of components.

Currently, even systems that can remotely trip or close an MCCB do not provide the operator with continuous or real time feedback on if the system is operating as expected or not. This can be hazardous if the operator must visually inspect the system to determine if there is an issue with the tripping or closing procedure, placing the operator in harms way.

### SUMMARY OF THE INVENTION

According to a first aspect, a remote switch actuator includes an actuator housing having a push plate coupled to a pair of actuator pins, the push plate having a first state where the push plate is disposed about an end of an actuation path and a second state where the push plate is disposed about an opposed end of the actuation path. The remote switch actuator may further include at least one sensor positioned within the actuator housing and configured to continuously detect the position of the push plate along the actuation path. The remote switch actuator may further include a switch controller communicatively coupled to the actuator housing and the at least one sensor and having a user interface configured to display the position of the push plate sensed by the at least one sensor.

According to a second aspect, a remote switch actuator system includes an actuator housing having an actuation path defined by an elongated opening and a push plate coupled to a pair of actuator pins positioned about the actuation path. The remote switch actuator system may further include a motor mechanically coupled to the push plate and configured to move the push plate in a first direction and a second direction along the actuation path. The remote switch actuator system may further include a sensor configured to detect a position of the push plate along the actuation path. The remote switch actuator system may further include a controller communicatively and electrically coupled to the motor and the sensor and having a user interface configured to display the position of the push plate sensed by the sensor and receive a user's input, the controller configured to receive the user's input indicative of a desired position of the push plate along the actuation path at the user interface. The controller may further be configured to cause the motor to activate to move the push plate along the actuation path in response to receiving the user's input. The controller may further be configured to receive data from the sensor regarding the position of the push plate along the actuation path. The controller may further be configured to cause the user interface to display the sensed position of the push plate along the actuation path in response to receiving the data from the sensor.

According to a third aspect, a method of operating a remote switch actuator with continuous feedback includes receiving a user's input indicative of a desired position of a push plate along an actuation path at a user interface. The method may further include activating a motor to move the push plate along the actuation path in response to receiving the user's input. The method may further include sensing, via a sensor, the position of the push plate along the actuation path. The method may further include displaying, via a display module, the sensed position of the push plate along the actuation path.

### BRIEF DESCRIPTION OF THE DRAWINGS

The disclosure will become more fully understood from the following detailed description, taken in conjunction with the accompanying representative figures, wherein like reference numerals refer to like elements, in which:

FIG. 1 is a front side perspective view of an embodiment of a remote switch actuator with continuous feedback system.

FIG. 2 is a front side perspective view of an embodiment of a remote switch actuator.

FIG. 3 is a rear side perspective view of an embodiment of a remote switch actuator.

FIG. 4 is a front side perspective view of an embodiment of a remote switch actuator with the front cover removed.

FIG. 5 is a front plan view of an embodiment of a remote switch controller.

FIG. 6 is a block diagram illustration of an embodiment of a remote switch actuator with continuous feedback system.

FIG. 7 is a flowchart illustrating a method for using a remote switch actuator with continuous feedback system according to an embodiment.

The drawings are not necessarily to scale and certain features may be shown exaggerated in scale or in somewhat schematic form in the interest of clarity and conciseness.

### DETAILED DESCRIPTION

In operation, an operator may monitor the progress of the remote switch actuator 10 as the push plate 28 moves along the actuation path 32 on the user interface 46 of the remote switch controller 12. Knowing the real time progress of where the switch handle 18 of the MCCB 16 is during a manual trip procedure, or other similar procedure such as a closing procedure, is important for maximizing a user's safety. If the switch handle 18 of the MCCB 16 becomes stuck midway through a manual trip procedure (i.e., partially between the first state and the second state, as discussed below) or a manual close procedure (i.e., partially between the second state and the first state, as discussed below) due to an internal failure of the MCCB 16, without the user's knowledge, the user may enter into an unsafe environment. To more fully inform a user of the position of the switch handle 18 during such procedures, the remote switch controller 12 is configured to display position data of the switch handle 18 on a display 48 of the user interface 46. This position data is updated continuously by a sensor 37 that is configured to sense or detect the position of the push plate 28 along the actuation path 32.

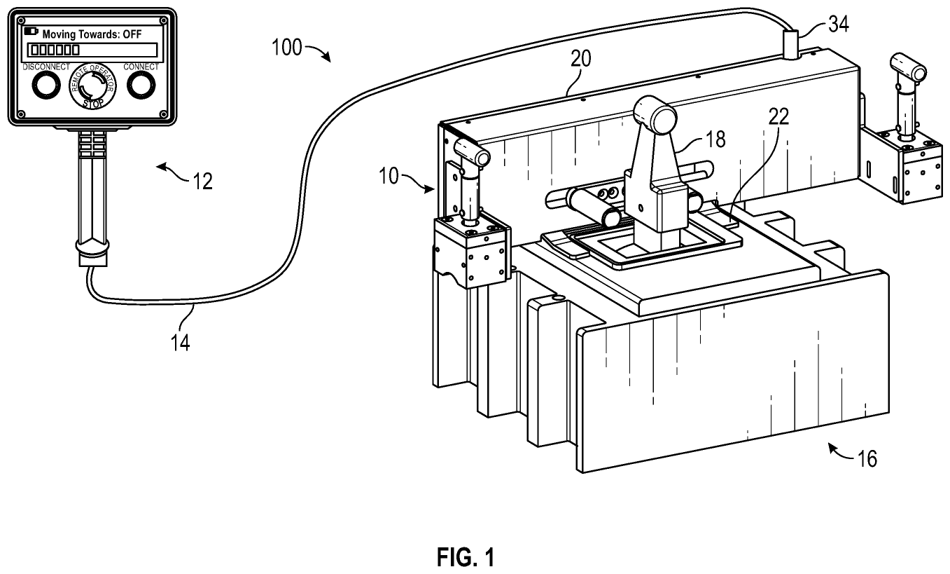

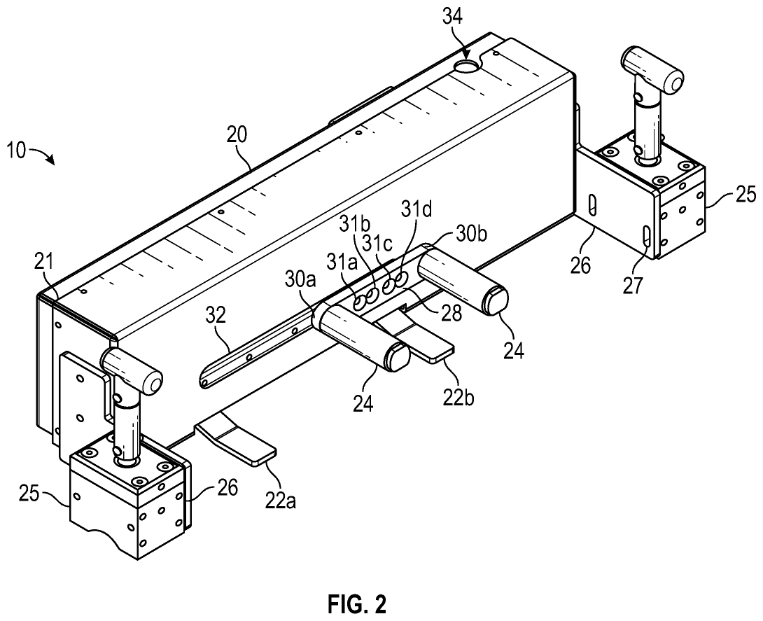

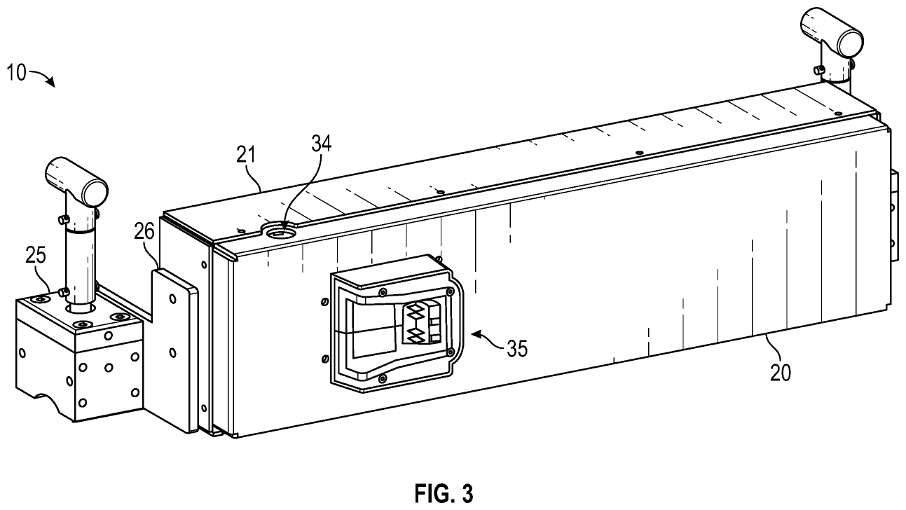

Rereferring now to FIGS. 1-3, which depicts a front side perspective view of an embodiment of a remote switch actuator with continuous feedback system 100 (FIG. 1), a front side perspective view of a remote switch actuator 10 (FIG. 2), and a rear side perspective view of a remote switch actuator 10 (FIG. 3) respectively. The remote switch actuator with continuous feedback system 100 includes a remote switch actuator 10, and a remote switch controller 12 electrically and communicatively coupled to the remote switch actuator 10 by a cable 14. FIG. 1 shows the remote switch actuator with continuous feedback system 100 coupled to an MCCB 16 with a switch handle 18. The remote switch actuator with continuous feedback system 100 is configured to transition the switch handle 18 from a first state (sometimes referred to as a “connected state,” a “closed state,” an “engaged state,” an “enabled state,” a “latched state,” an “energized state,” an “operational state,” an “un-tripped state,” or an “ON state”) to a second state (sometimes referred to as a “disconnected state,” an “open state,” a “disengaged state,” a “disabled state,” an “unlatched state,” a “de-energized state,” a “non-operational state,” a “tripped state,” or an “OFF state”) while an operator or user is positioned remotely from the remote switch actuator 10. The user may input a command at the remote switch controller 12 to cause the push plate 28 to move along the actuation path 32 in a direction. While the push plate 28 is moving in the direction, at least one actuator pin 24 is caused to contact at least a portion of the switch handle 18. As the push plate 28 continues to move in the direction, the switch handle 18 is accordingly moved in the same direction towards the desired state (the first state, the connected state, the on state, the second state, the disconnected state, the off state, etc.). Accordingly, as the position of the push plate 28 along the actuation path 32 is indicative of and generally correlated with the position of the switch handle 18 of the MCCB 16, measuring, detecting, sensing, or otherwise knowing the position of the push plate 28 along the actuation path 32 will generally correlate to the position of the switch handle 18 between the first state and the second state.

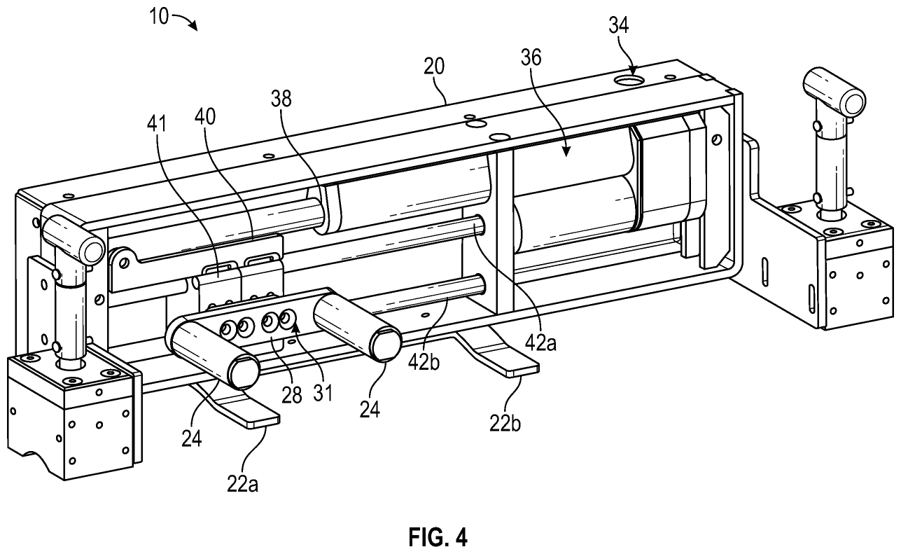

In use, the magnetic mounts 25 are first magnetically coupled to or about the structure or cabinet that houses the MCCB 16. The mounting plates 26 are configured to facilitate coupling the actuator housing 20 to the magnetic mounts 25 about the mounting holes 27. The mounting plates 26 have or include mounting holes 27 that are defined by an elongated opening to allow for adjustment of the mounting height of the actuator housing 20 with respect to the MCCB 16. The height adjustment provided by the mounting holes 27 of the mounting plates 26 is necessary to ensure that the bottom surface of the locator bracket 22 contact a top surface of the MCCB 16. If the locator bracket 22 does not contact the MCCB 16, the actuator housing 20 may be adjusted downward towards the top surface of the MCCB 16 via adjusting the mounting hole 27 downwards with respect to the magnetic mounts 25. The locator bracket 22 has a first extension member 22a and a second extension member 22b that are configured to contacts the MCCB 16 and aid the user in properly positioning the remote switch actuator 10 about the switch handle 18 of the MCCB 16. The push plate 28 has actuator pin mounting locations 30a and 30b (collectively 30) that are configured to receive, accept, or otherwise couple to the actuator pins 24. The actuator pins 24 are configured to couple to the push plate 28 such that a movement of the push plate 28 results in a similar movement of the actuator pins 24. The actuator pins 24 are positioned about the actuator pin mounting location 30 that positions the MCCB 16 switch handle 18 between the pair of actuator pins 24. In this manner, the push plate 28 may move in the first direction along the actuation path 32 such that one of the actuator pins 24 contacts the switch handle 18. The push plate 28 also includes actuator mounting holes 31a, 31b, 31c, and 31d (collectively 31) that are configured to mount or otherwise mechanically couple the push plate 28 to a mounting block 41 (shown in FIG. 4) such that a movement of the mounting block 41 results in a movement of the push plate 28. The push plate 28 may also move in the second direction along the actuation path 32 such that the other actuator pin 24 contacts the switch handle 18. As the push plate 28 continues to move in the first or second direction along the actuation path 32, the switch handle 18 of the MCCB 16 is further caused to move towards the first or second state to the other state. For example, if the switch handle 18 of the MCCB 16 is positioned about the first state and the actuator pins 24, moving in conjunction with the push plate 28, begin moving in the second direction, the actuator pin 24 contacting the switch handle 18 will cause the switch handle 18 to transition from the first state to the second state, and vice versa.

The actuator connector 34 is configured to be electrically and communicatively coupled to the sensor 37 and the motor 36 and at least a portion of the actuator connector 34 is accessible about the exterior of the actuator housing 20. The actuator connector 34 is also configured to couple to the cable 14 such that the processor 58 may send instructions to the motor 36 to actuate or otherwise cause the motor 36 to move the push plate 28 in a direction along the actuation path 32. The actuator connector 34 is also configured to couple to the cable 14 such that the processor 58 may receive data from the sensor 37 that is indicative of the position of the push plate 28 along the actuation path 32. In some embodiments, the actuator connector 34 has or otherwise includes a wireless communications module configured to wirelessly communicate with the processor 58 of the remote switch controller 12. In such embodiments, the cable 14 is not necessary to communicate instructions from the processor 58 to the motor 36 or transmit data from the sensor 37 to the processor 58 and as such may be omitted. In some embodiments, the motor 36 is a linear actuator that is configured to linearly move in the first or second direction in response to receiving a corresponding signal from the remote switch controller 12.

The remote switch actuator with continuous feedback power system 100 also includes a power source 35. The power source 35 may be a rechargeable power source 35 that is configured to accept and electrically couple to rechargeable batteries, for example, tool batteries such as the Milwaukee M18 battery, the DeWalt 20V MAX battery, the Ryobi 18V ONE+ battery, the Makita 18V LXT battery, the Bosch 18V BAT620 battery, the Craftsman V20 battery, the Porter-Cable 20V MAX battery, or any other rechargeable or non-rechargeable battery. The power source 35 may also be configured to electrically couple to a constant power source such as a wall outlet or otherwise. The power source 35 is configured to be electrically and communicatively coupled to the remote switch controller 12 such that the power source 35 may provide electrical power to the remote switch controller 12 via the cable 14.

In many embodiments, the remote switch actuator 10 may have modular components to facilitate the coupling or the ability to couple the remote switch actuator 10 to various models or types of MCCB's from various manufacturers. While almost all MCCBs 16 function or operate in substantially similar manners, the physical embodiments of MCCBs 16 manufactured by different manufacturers may differ. Remote switch actuators 10 with modular components can have the components necessary for mounting or otherwise coupling to or about various types of MCCBs 16 by swapping out some of the modular components for ones that are compatible for the particular type of MCCB 16 being coupled to at that time. Examples of modular components include the locator bracket 22, the actuator pins 24, the magnetic mounts 25, the mounting plates 26, and the push plate 28. For example, the locator bracket 22 for an MCCB manufactured by Manufacturer A may have extension members 22a, 22b that are positioned farther apart or closer together than a locator bracket 22 configured to be compatible with an MCCB 16 manufactured by Manufacturer B. The locator bracket 22 may have a different profile or overall structure depending on the particular MCCB 16 that it is configured to be compatible with. The mounting plates 26 may be modular with mounting holes 27 of varying heights to accommodate for various styles or manufacturers of cabinets or structures that the MCCBs 16 are mounted within and various styles or manufacturers of particular MCCBs 16.

Similarly, the actuator pins 24 may be modular such that certain actuator pins 24 have a larger or smaller diameter, a larger or smaller overall length, or include an external wrapping of material such as a conductive material or a non-conductive material such as rubber or plastic when configured to be compatible with certain MCCB's 16. Certain actuator pins 24 may be configured to only couple to certain push plates 28 or certain actuator pin mounting locations 30 about certain push plates 28. The push plate 28 may be modular such that push plate 28 may have fewer or more actuator pin mounting locations 30, the push plate 28 may also have a longer or shorter length to accommodate switch handles 18 of varying sizes.

Reference is now made to FIG. 4, which depicts a front side perspective view of a remote switch actuator 10 with the front cover 21 removed. Here, the internal construction of a remote switch actuator 10 can be seen such as the motor 36 coupled to the shaft 38, the actuation coupler 40 which is configured to couple push plate 28 to the shaft 38, the mounting block 41, the top guide pin 42a and the bottom guide pin 42b (collectively 42). The mounting block 41 is configured to be movable along the guide pins 42 and is configured to couple to the push plate 28 about the actuator mounting holes 31 of the push plate 28. The mounting block 41 can be configured to couple to the actuator mounting holes 31 by a plurality of studs extending from a surface of the mounting block 41 that are substantially aligned with the actuator mounting holes 31 such that the actuator mounting holes 31 may receive the studs extending from the surface of the mounting block 41. Then female threaded members (not shown) can be threaded onto the portion of the studs protruding out from the actuator mounting holes 31. The mounting block 41 can also be configured to couple to the actuator mounting holes 31 via a plurality of mounting block holes (not shown) substantially aligned with the actuator mounting holes 31 such that a male threaded member (not shown) may be threaded into the mounting block holes through the actuator mounting holes 31. The actuation coupler 40 is configured to connect or otherwise mechanically couple the push plate 28 to the shaft 38 such that a movement of the shaft 38 in a first direction causes the push plate 28 to move in the same first direction and that a movement of the shaft 38 in a second direction causes the push plate 28 to move in the same second direction. The motor 36 is configured to move the shaft 38 in a first direction away from the motor 36 and in an opposed second direction towards the motor 36. The sensor 37 (not shown) may be positioned within the actuator housing 20 such that the sensor 37 may sense, detect, or otherwise track the position of the push plate 28 as it moves along the actuation path 32.

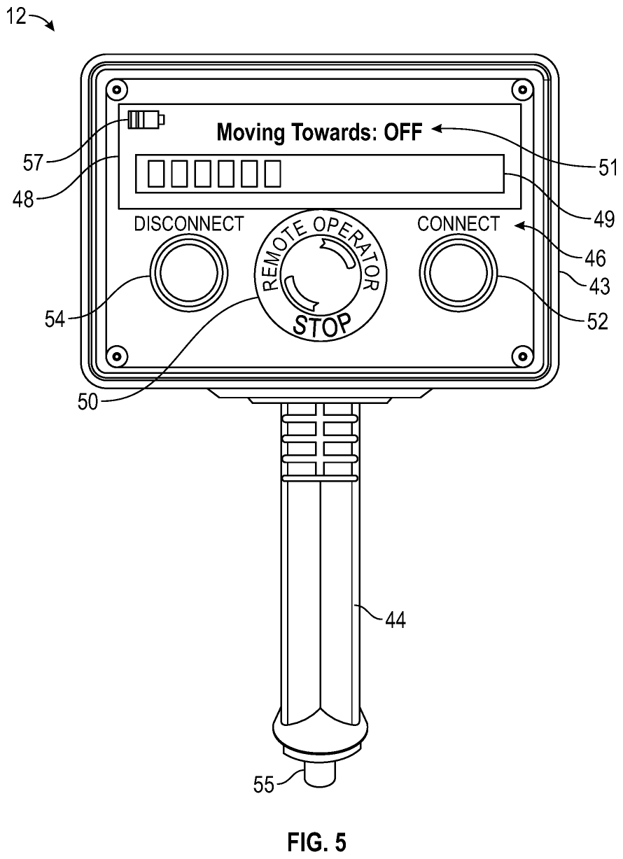

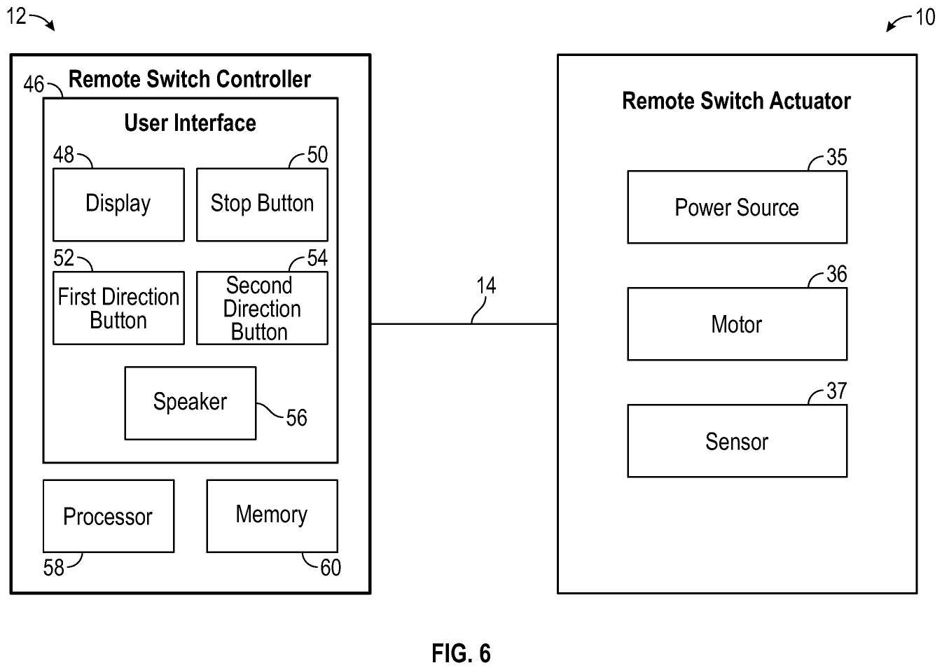

Reference is now made to FIGS. 5-6, which depicts a front side plan view of an embodiment of a remote switch controller 12. The remote switch controller 12 includes a remote housing 43 with a handle 44, a user interface 46, and a switch connector 55. The user interface 46 includes a display 48, a stop button 50, a first direction button 52, and a second direction button 54. The remote switch controller 12 is configured to provide or facilitate remote control of the remote switch actuator 10 by a user positioned remotely from the remote switch actuator 10. The remote switch controller 12 is electrically and communicatively coupled to the remote switch actuator 10 via the cable 14. The switch connector 55 is configured to electrically and communicatively couple the remote switch controller 12 to an end of the cable 14.

The user interface 46 is configured to display data or information on the display 48 that is relevant to the user and receive inputs from a user about various buttons (e.g., the stop button 50, the first direction button 52, the second direction button 54, etc.). Pressing or actuating the first direction button 52 will cause the processor 58 to send instructions to the motor 36 to move the push plate 28 in the first direction. In some embodiments, when the first direction button 52 is released by the user, the processor 58 may be configured to cease sending instructions to the motor 36, thereby causing the motor 36 to halt or stop moving the push plate 28 along the actuation path 32. For example, if the user presses the first direction button 52, the processor 58 will recognize that the first direction button 52 has been pressed and send a signal to the motor 36 to cause it to move in the first direction. As another example, if the first direction button 52 has been pressed, and the display 48 depicts that the progress indicator 49 has not progressed over a period of time, the user may press the stop button 50 to halt the operation of the motor 36.

The display 48 may include a progress indicator 49 and a current operation status 51. The progress indicator 49 is communicatively and electrically coupled to the processor 58 and the memory 60. The progress indicator 49 is configured to receive data from the processor 58 that is indicative of a position of the push plate 28 along the actuation path 32 and display a representation of the position of the push plate 28 along the actuation path 32 on the progress indicator 49. For example, the progress indicator may be configured as a loading bar such that if the loading bar shows approximately 50% of the bar filled (with the other 50% of the loading bar un-filled) then that would be representative of the push plate 28 being positioned at approximately the half-way or mid-way point of the actuation path 32. The progress indicator 49 may also be electrically and communicatively coupled with a speaker 56. In some embodiments, speaker 56 can be configured to audibly announce the progress represented on the progress indicator 49 at predetermined intervals (e.g., 25%, 33%, 50%, 66%, 75%, 100%, or any other intermediary point or percentage therein). For example, when the progress indicator 49 indicates that the push plate 28 is approximately halfway along the actuation path 32, the speaker 56 may be configured to produce an audible alert such as “HALFWAY,” “MIDWAY,” “HALF,” or any other desirable or suitable audible alert. Speaker 56 may also be communicatively and electrically coupled to the processor 58 and may be further configured to produce audible alerts indicative of administrative notifications, such as maintenance intervals for certain components, alerts indicative of a problem or issue requiring a user attention or intervention, or any other suitable or desirable audible alert. It should be understood that while the progress indicator 49 is presently depicted as a loading bar, other configurations are also envisioned. For example, the progress indicator 49 may be a series of individual light emitting diodes (“LEDs”) where each individual LED correlates to a position of the push plate 28 along the actuation path 32. As another example, the progress indicator 49 may also be depicted as a numerical percentage such as 10%, 12%, 15%, 33%, 57%, 83%, 97%, 100%, or any other intermediary percentage between 0% and 100%. In such embodiments, the percentages depicted may correlate directly to a position along the actuation path such that 100% is always indicative of the first state or the second state. The percentages depicted by the progress indicator 49 may also correlate relatively such that 100% is always indicative of the push plate 28 being positioned at the end of the actuation path 32 that corresponds with the direction button 52, 54 that the user pressed or actuated.

The display 48 may also be configured to display or depict the current operation status 51. The current operation status 51 maybe indicative of the current operation or set of instructions being sent to the motor 36 from the processor 58. The current operation status 51 may indicate if the push plate 28 is moving or not moving. The current operation status 51 may also indicate in which direction (e.g., first direction, second direction, etc.) that the push plate 28 is moving towards. The current operation status 51 may be configured to display administrative notifications such as maintenance required on one or more components or whether or not the remote switch controller 12 is currently connected to the remote switch actuator 10. The display 48 can also be configured to display an alert if the processor 58 is sending instructions to the motor 36 to move the push plate 28 along the actuation path 32 and the position of the push plate 28 sensed by the sensor 37 has not substantially changed over a predetermined amount of time. Such a scenario is indicative of a switch handle 18 of an MCCB 16 being stuck in a certain position and may require further inspection or manual intervention from a user. The speaker 56 can also be configured to provide an audible alert in such scenarios.

In some embodiments, the user interface 46 may be a touch sensitive screen such that the stop button 50, the first direction button 52, and the second direction button 54 are virtual buttons that are configured to actuate when the portion of the touch sensitive user interface 46 having the virtual buttons is touched by a user. In other embodiments, the user interface 46 can be configured to display the remaining battery life 57 in embodiments that utilize batteries with the power source 35.

In some embodiments, the motor 36 is a stepper motor 36 and the shaft 38 is a threaded shaft 38 configured to rotate in the clockwise and counter-clockwise directions. As such, rotating the threaded shaft 38 in the clockwise direction a predetermined number of degrees will cause the actuation coupler 40 to move linearly along the threaded shaft 38 a predetermined distance in a direction. Conversely, rotating the threaded shaft 38 in the counter-clockwise direction a predetermined number of degrees will cause the actuation coupler 40 to move linearly along the threaded shaft 38 a predetermined distance in the opposite direction. Additionally, the stepper motor 36 can have, include, or be otherwise electrically coupled to an encoder configured to measure the number of rotations and direction of rotation of the stepper motor 36. Encoders provide feedback in the form of pulses, which can be counted to track the position of the stepper motor 36 and, by extension, the threaded shaft 38 and the push plate 28. By knowing the pitch of the screw threads on the threaded shaft 38 and the number of rotations of the stepper motor 36, the position of the push plate 28 along its path can be calculated. This position information can then be translated into a percentage or another unit of measurement for display to the operator.

In some embodiments, the sensor 37 can be a linear potentiometer. Linear potentiometers work by utilizing a resistive element that changes resistance along its length in response to the linear displacement of a sliding contact. This resistive element is typically a conductive track, and the sliding contact is connected to the object whose position needs to be measured, such as the push plate 28. As the object moves, the position of the sliding contact along the resistive track changes, altering the resistance between the contact and each end of the track. By applying a constant voltage across the ends of the track and measuring the voltage at the sliding contact, the position of the object can be determined. This voltage is proportional to the position of the sliding contact along the resistive track, providing a direct indication of the object's linear displacement. In such embodiments where the sensor 37, is a linear potentiometer, one or both of the guide pins 42a, 42b, can be the resistive track that a constant voltage is applied to with an electrical contact mechanically coupled to the push plate 28 and electrically coupled to the remote switch controller 12. As such, any movement of the push plate 28 along the guide pins 42 will cause the voltage measured at the electrical contact by the remote switch controller 12 to change.

In many embodiments, the sensor 37 is a linear variable differential transformer (“LVDT”) which is a type of sensor 37 that can measure linear displacement of an object. LVDTs detect or sense changes in the position of a movable armature relative to a fixed coil assembly. An LVDT consists of a primary coil and two secondary coils wound on a cylindrical core, with a movable ferromagnetic armature placed within the cylindrical core about the primary coil. The linear movement of the ferromagnetic core may be sensed or detected by changes in voltage registered by the primary and secondary coils. In such embodiments, the ferromagnetic armature is attached to, secured to, or otherwise mechanically to the push plate 28. By placing LVDT sensor 37 such that the ferromagnetic armature is positioned to move along the actuation path 32 in conjunction with the push plate 28 moving along the actuation path 32, the position of the push plate 28 can be determined based on the voltages sensed by the LVDT sensor 37. In many embodiments, the sensor 37 is a plurality of hall effect sensors 37. Hall effect sensors 37 may be employed to detect the presence or absence of a magnetic field generated by a magnet attached to, secured to, or otherwise mechanically to the push plate 28. By placing multiple hall effect sensors 37 along the actuation path 32, such as coupled to the rear wall of the actuator housing 20, the position of the push plate 28 can be determined based on which sensors 37 are activated. As such, moving the push plate 28 along the actuation path 32 will bring the magnet coupled to the push plate 28 closer to and farther away from any one individual hall effect sensor 37 of the plurality of hall effect sensors 37.

In some embodiments, the sensor 37 can be a current limiting sensor coupled to the motor 36. The current limiting sensor 37 can be configured to detect the electrical current provided to the motor 36 over a period of time and correlate it with the position of the push plate 28 along the actuation path 32. For example, if the power source 35 provides 2.5 amps to the motor 36 for 1 minute, this output can be correlated to the push plate 28 being moved 3 inches in a direction along the push plate 28. It should be understood that the current limiting sensor 37 may need to be calibrated to the type of motor 36 utilized, the manufacturer of the motor 36 utilized, and/or the specific model of motor 36 utilized. Calibrating the motor 36 to the current limiting sensor 37 ensures that the remote switch controller 12 can accurately display the position of the push plate 28 along the actuation path 32.

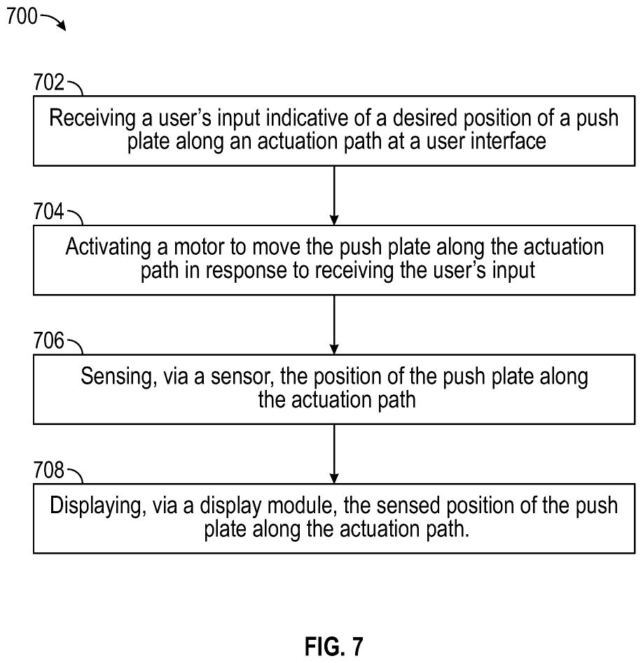

Reference is now made to FIG. 7, which depicts a flowchart illustration of a method 700 of using a remote switch actuator with continuous feedback system 100. The method 700 including step 702 of receiving a user's input indicative of a desired position of a push plate 28 along an actuation path 32 at a user interface 46. The method 700 may further include step 704 of activating a motor 36 to move the push plate 28 along the actuation path 32 in response to receiving the user's input. The method 700 may further include step 706 of sensing, via a sensor 37, the position of the push plate 28 along the actuation path 32. The method 700 may further include step 708 of displaying, via a display module 48, the sensed position of the push plate 28 along the actuation path 32.

In some embodiments, the extension members 22a, 22b are separate members that are each individually coupled to the remote switch actuator 10 or the locator bracket 22. In other embodiments, the extension members 22a, 22b are integral to or otherwise connected to the locator bracket 22 such that the extension members 22a, 22b are extensions of a singular component.

In some embodiments, the remote switch actuator with continuous feedback system 100 may be utilized with MCCBs 16 or any other type of electrical circuit breaker. For example, the remote switch actuator with continuous feedback system 100 may be utilized with miniature circuit breakers (“MCBs”) which are commonly used in residential and light commercial applications and provide overcurrent protection and are designed for relatively low current ratings, typically up to 125 amps. As another example, the remote switch actuator with continuous feedback system 100 may be utilized with air circuit breakers which are used in larger industrial and commercial applications and provide overcurrent protection and are typically capable of handling higher current ratings than MCCBs, generally ranging from several hundred to several thousand amps. As another example, the remote switch actuator with continuous feedback system 100 may be utilized with residual current circuit breakers, also known as ground fault circuit interrupters or residual current devices, which are designed to protect against electrical shock by detecting imbalances in the electrical current and are commonly used in residential and commercial installations, especially in areas where electrical equipment may come into contact with water. As another example, the remote switch actuator with continuous feedback system 100 may be utilized with motor control center switches, safety switches, load break switches, load interrupt switches, panelboard switches, medium voltage motor control center switches, insulated case circuit breakers, bolted pressure switches, or any other type of electrical component with a switch handle 18 or other similar feature. It should be understood that the remote switch actuator with continuous feedback system 100 may be utilized with any electrical breaker having a switch handle 18 that is used to trip the breaker or otherwise transition the breaker between a connected state and a disconnected state and vice versa.

In other embodiments, the remote switch actuator with continuous feedback system 100 may be utilized to rack an MCCB 16 into and out of its operational position. In this manner, the push plate 28 is configured to couple to an MCCB 16 and positioned such that the push plate 28 moves along an axis that is perpendicular to the MCCB 16. In this manner, as the push plate 28 moves farther away from the rack that the MCCB 16 is mounted within, the MCCB 16 moves along with it and vice versa. As the movement of the MCCB 16 correlates to the movement of the push plate 28, tracking the position of the push plate 28 allows for real time tracking of the position of the MCCB 16 with respect to the rack that is was mounted within.

Although embodiments of a remote switch actuator with continuous feedback system 100 and method 700 of using a remote switch actuator with continuous feedback system 100 have been described in detail, those skilled in the art will also recognize that various substitutions and modifications may be made without departing from the scope and spirit of the appended claims.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and “right,” “front” and “rear,” “above” and “below” and the like are used as words of convenience to provide reference points and are not to be construed as limiting terms.

In this specification, the word “comprising” is to be understood in its “open” sense, that is, in the sense of “including,” and thus not limited to its “closed” sense, that is the sense of “consisting only of.” A corresponding meaning is to be attributed to the corresponding words “comprise,” “comprised” and “comprises” where they appear.

In addition, the foregoing describes some embodiments of the disclosure, and alterations, modifications, additions and/or changes can be made thereto without departing from the scope and spirit of the disclosed embodiments, the embodiments being illustrative and not restrictive.

Furthermore, the disclosure is not to be limited to the illustrated implementations, but to the contrary, is intended to cover various modifications and equivalent arrangements included within the spirit and scope of the disclosure. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A remote switch actuator, comprising:
an actuator housing having a push plate coupled to a pair of actuator pins, the push plate having a first state where the push plate is disposed about an end of an actuation path and a second state where the push plate is disposed about an opposed end of the actuation path;
at least one sensor positioned within the actuator housing and configured to continuously detect a position of the push plate along the actuation path; and
a switch controller communicatively coupled to the actuator housing and the at least one sensor and having a user interface configured to display the position of the push plate sensed by the at least one sensor.

2. The remote switch actuator of claim 1, wherein the at least one sensor is a linear potentiometer.

3. The remote switch actuator of claim 1, wherein the at least one sensor is a linear variable differential transformer.

4. The remote switch actuator of claim 1, wherein the at least one sensor is a hall effect sensor.

5. The remote switch actuator of claim 1, wherein the at least one sensor is an encoder coupled to a stepper motor.

6. The remote switch actuator of claim 1, wherein the actuation path is defined by an opening extending through a portion of the actuator housing.

7. The remote switch actuator of claim 1, wherein the user interface further includes at least one button that when actuated, causes the push plate to move towards the first state.

8. A remote switch actuator system comprising:
an actuator housing having an actuation path defined by an elongated opening and a push plate coupled to a pair of actuator pins positioned about the actuation path;
a motor mechanically coupled to the push plate and configured to move the push plate in a first direction and a second direction along the actuation path;
a sensor configured to detect a position of the push plate along the actuation path;
a controller communicatively and electrically coupled to the motor and the sensor and having a user interface configured to display the position of the push plate sensed by the sensor and receive a user's input, the controller configured to;
receive the user's input indicative of a desired position of the push plate along the actuation path at the user interface;
in response to receiving the user's input, cause the motor to activate to move the push plate along the actuation path;
receive data from the sensor regarding the position of the push plate along the actuation path; and
in response to receiving the data from the sensor, cause the user interface to display the sensed position of the push plate along the actuation path.

9. The remote switch actuator system of claim 8, wherein the sensor is a linear potentiometer.

10. The remote switch actuator system of claim 8, wherein the sensor is a linear variable differential transformer.

11. The remote switch actuator system of claim 8, wherein the sensor is a hall effect sensor.

12. The remote switch actuator system of claim 8, wherein the sensor is an encoder and the motor is a stepper motor coupled to the encoder.

13. The remote switch actuator system of claim 8, wherein the user interface further includes at least one button that when actuated, causes the push plate to move towards an end of the actuation path.

14. The remote switch actuator system of claim 8, wherein the user interface further includes a speaker.

15. A method of operating a remote switch actuator with continuous feedback, the method comprising:
receiving a user's input indicative of a desired position of a push plate along an actuation path at a user interface;
activating a motor to move the push plate along the actuation path in response to receiving the user's input;
sensing, via a sensor, a position of the push plate along the actuation path; and
displaying, via a display module, the sensed position of the push plate along the actuation path.

16. The method of claim 15, wherein the sensor is a linear potentiometer.

17. The method of claim 15, wherein the sensor is a linear variable differential transformer.

18. The method of claim 15, wherein the sensor is a hall effect sensor.

19. The method of claim 15, wherein the sensor is an encoder and the motor is a stepper motor coupled to the encoder.

20. The method of claim 15, further comprising displaying, via the display module, an alert if the position sensed by the sensor has not changed over a predetermined amount of time.
